(19) United States
(12) Patent Application Publication
(10) Pub. No.: US 2006/0102742 A1
(43) Pub. Date: May 18, 2006

(54) Fuel delivery system

(76) Inventor: Shaun Thomas Rigney, Doncaster East (AU)

Correspondence Address: KENNETH M. FAGIN, 136 SUMMER WALK DRIVE, GAITHERSBURG, MD, 20878, US

(21) Appl. No.: 10/544,385

(22) PCT Filed: Feb. 13, 2004
(86) PCT No.: PCT/AU04/00177

§ 371 Date: Aug. 12, 2005

(30) Foreign Application Priority Data
Feb. 13, 2003 (AU) 2003900748

(51) Int. Cl. F02M 47/02; F02M 63/00; F02M 43/00; F02M 59/00

(52) U.S. Cl. 239/88; 239/89; 239/91; 239/533.2; 239/533.3

(57) ABSTRACT

A fuel delivery system and fuel injector is disclosed. The fuel delivery system includes a bore (18) which is formed in the head (10) of the engine and a fuel injector (21) is located in the bore (18). The bore (18) has an open end. The heating chamber (40) is defined between the fuel injector and the wall (18a) of the bore (18). The injector has a fuel storage section which is located within the heating chamber and during a compression stroke of the piston of the engine, gas in the combustion chamber of the engine is compressed and forced through the open end of the bore into the chamber to heat the fuel storage section of the injector. In an alternative arrangement, the injector is provided with an enlarged end region (110) which fits into the bore of the engine and makes contact with the peripheral wall of the bore so that heat is conducted from the engine via the peripheral wall of the bore into the enlarged section of the injector to heat the fuel within the end region of the injector.

### FIELD OF THE INVENTION

This invention relates to a fuel delivery system and, in particular, to a direct injection fuel delivery system for both diesel and petrol or gasoline engines, and also to an injector and fuel delivery system for such systems.

### BACKGROUND OF THE INVENTION

Our International Application No. PCT/AU02/00403 discloses a fuel delivery system in which fuel is injected into an air intake stream in order for the fuel to be delivered to a combustion chamber of the engine. The contents of this International application are incorporated into this specification by this reference.

In diesel engines and in direct injection petrol engines, fuel is delivered direct to the combustion chamber or a secondary chamber directly linked to the combustion chamber (herein collectively referred to as the combustion chamber) rather than into the air intake stream.

### SUMMARY OF THE INVENTION

The object of one aspect of the present invention is to provide a fuel delivery system which utilises the principles of the above International application, but which is applicable to a direct injection engine.

This aspect of the invention may be said to reside in a fuel delivery system for an engine which has a combustion chamber, a piston moveable in the combustion chamber, an air inlet port and an exhaust port, comprising:

a bore in the engine having a first open end communicating with the combustion chamber, and a second end remote from the first end, the bore having a bore wall;

a fuel injector located in the bore and having an injection tip adjacent the first end for direct injection of fuel into the combustion chamber, the injector having a fuel storage section in which fuel is stored for ejection from the injector and an operating section for operating the injector to eject the fuel from the tip of the injector;

the second end of the bore being closed;

a heating chamber defined by the bore wall, the closed second end of the bore and the injector;

the injector being located in the bore so that the fuel storage section is within the heating chamber; and

wherein during a compression stroke of the piston gas within the combustion chamber is compressed and forced through the first open end of the bore into the chamber to heat the fuel storage section of the injector so as to raise the temperature of the fuel in the fuel storage section so that as soon as the fuel leaves the injector, the fuel substantially immediately converts to vapour state because of the heating of the fuel and the change in pressure experienced by the fuel when the fuel leaves the injector and enters the chamber.

Thus, according to this aspect of the invention, the fuel is heated by the compression of the gases within the cylinder during the compression strokes of the piston. In the case of a diesel engine in which the engine operates at very high compression ratio, the heating is greater because of the higher compression pressure within the engine, thereby enabling the rather thicker diesel fuel to be adequately heated to ensure that it converts to vapour upon ejection from the injector. In the case of a petrol or gasoline engine which operates at a lower pressure, the heating is not as great, but nevertheless sufficient to heat the temperature to cause the petrol or gasoline to rise to the required temperature in order to immediately convert to vapour upon injection of the fuel. Thus, the required heating is to some extent automatically regulated depending on the type of engine (ie. whether it be a diesel engine or spark ignited petrol engine) and the fuel which is being used. The invention also has the advantage that additional heating elements are not required and additional plumbing or significant modifications to the engine are also not required.

The operating section of the injector may be a mechanical operating section which is operated by fuel pressure, or an electric solenoid type operating section, to thereby enable the fuel to be ejected at the required time by the injector.

In the case of a mechanical operating section, it is preferred that the injector be located in the bore so that the mechanical operating section is exterior of the heating chamber. However, this is not essential. In the case of an electric operating section, the electric operating section should be exterior of the chamber to prevent the heating within the chamber from destroying the electric operating section of the injector. In other words, by locating the electric operating section outside the chamber, it is maintained relatively cool, thereby not damaging the electric components within the operating section.

In the preferred embodiment of the invention, the bore has an inwardly directed flange and a collar located on the flange for receiving an end of the injector so as to raise the injector slightly in the bore and to provide a passage through which the gases compressed in the cylinder can pass into the heating chamber.

Preferably the second end of the bore is closed by a sealing element.

The sealing element may be an O-ring type seal, a plate or any other element for sealing the second end of the bore to prevent gases within the combustion chamber from exiting the bore through the second end.

In one embodiment, the sealing element is a shoulder formed on the injector remote from the tip for sealing the second end of the bore.

The collar may be a generally annular ring and may include apertures or holes to facilitate the passage of gas from the combustion chamber into the heating chamber, and from the heating chamber back into the combustion chamber.

Another aspect of the invention is concerned with an injector configuration which can take advantage of the principles of the above International application, as well as a fuel delivery system using that injector.

Accordingly to this aspect of the invention there is provided a fuel injector for a fuel delivery system for delivering fuel to a cylinder of a vehicle engine, the injector comprising:

an injector body having an end region which comprises a fuel storage section in which fuel is stored for ejection from the injector, and an operating section for operating the injector to eject the fuel from the end region; and

a heating component for substantially continuously heating the end region of the injector when the injector is in operation supplying fuel to the cylinder, to maintain the end region and therefore the fuel in the fuel storage section at a temperature so that when the fuel is ejected from the injector, the fuel immediately converts to a vapour state because of the elevated temperature of the fuel and the change in pressure experienced by the fuel when the fuel leaves the injector.

In the preferred embodiment of this aspect of the invention, the heating component comprises an enlarged end region of the injector which is dimensioned so that when the injector is inserted into an injector port of the vehicle engine, the enlarged end region is in thermal contact with a wall defining the injector port so that heat is transferred from the engine by direct conduction to the enlarged end region of the injector, and therefore to the fuel in the fuel storage section.

In other embodiments, the heating component could take other forms such as an electric form or heat by way of exhaust gas, provided that the heating is substantially constant so that the injector is continuously heated when the engine is operating, as distinct from heated only on initial start-up of the engine for overcoming problems with cold starting of the engine.

This aspect of the invention may also be said to reside in a fuel delivery system for a vehicle engine which includes a cylinder and an injector port having a wall, the fuel delivery system comprising:

an injector having an ejector body which is formed with an end region which comprises a fuel storage section in which fuel is stored for ejection from the injector, and an operating section for operating the injector to eject the fuel from the end region; and

the end region of the injector having a dimension so that at least part of the end region of the injector body makes thermal contact with the wall of the injector port so that during operation of the vehicle engine, heat is conducted from the engine via the wall of the injector port to the enlarged portion of the injector to thereby heat fuel in the fuel storage section so that when fuel is ejected from the injector, the fuel immediately converts to a vapour state because of the elevated temperature of the fuel and the change in pressure experienced by the fuel when the fuel leaves the injector.

Preferably the end region has an outer wall and the end region is dimensional so that substantially all of the outer wall contacts the wall of the injector port.

In the preferred embodiment of the invention, the end region is substantially cylinder or disc shape, and has an outer wall which contacts substantially the entirety of the wall of the injector port.

Preferably the end region includes a seal for sealing the end region in the injector port.

A further aspect of the invention provides an injector which has been designed to enable easy implementation of the first aspect of the invention.

Thus, the further aspect of the invention provides an injector for a fuel delivery system for delivering fuel to a cylinder of an engine, the engine having an injector port for receiving the injector, said injector comprising:

an injector body;

an end region extending from the injector body for storing fuel to be ejected from the injector, the end region having a first end from which the fuel is ejected, and a second end;

the end region having a dimension so that when the end region is located in the injector port, a heating chamber is formed between the end region of the injector and a wall of the injector port;

the first end of the injector being free of any seal so exhaust gas can move past the first end and into the chamber when the injector is located in the injector port and the engine is operating; and

a seal adjacent the second end of the end region for sealing the injector in the injector port.

Preferably the seal is formed by a shoulder located at the second end and which forms a transition between the end region and the injector body so that the shoulder can seat on part of an outer wall of the engine in which the injector port is formed.

Preferably the shoulder is a tapered annular wall for seating on a part of the outer wall of the engine at the periphery of the injector port.

### BRIEF DESCRIPTION OF THE DRAWINGS

A preferred embodiment of the invention will be described, by way of example, with reference to the accompanying drawings in which:

FIG. 1 is a view of a standard arrangement of a direct injection system;

FIG. 2 is a view according to a first embodiment of the invention;

FIG. 3A is a view of a collar according to one embodiment of the invention;

FIG. 3B is a cross-sectional view through the collar of FIG. 3A;

FIG. 3C is a side view of the collar of FIG. 3A;

FIG. 4A is a plan view of a collar according to a further embodiment;

FIG. 4B is a cross-sectional view of the collar of FIG. 4A;

FIG. 4C is a side view of the collar of FIG. 4A;

FIG. 5 is a view of a further embodiment of the invention;

FIG. 6 is a view of a still further embodiment of the invention;

FIGS. 7 and 7A are a plan view and cross-sectional view of a sealing element used in the embodiment of FIG. 5;

FIG. 8 and FIG. 8A are a plan view and cross-sectional view of a sealing element used in the embodiment of FIG. 6;

FIG. 9 and FIG. 9A are a plan view and cross-sectional view of a collar according to a still further embodiment;

FIG. 10 is a view of a prior art injector to illustrate the differences between such an injector and an injector according to a further embodiment of the invention;

FIG. 11 is a cross-sectional view of an injector according to the further embodiment of the invention;

FIG. 12 is a view of the injector of FIG. 11 fitted into an engine;

FIG. 13 is a view of a standard direct injection-type injector which can be used with diesel engines; and

FIG. 14 is a view of a modified injector according to yet another embodiment of the invention.

### DETAILED DESCRIPTION OF THE PREFERRED EMBODIMENTS

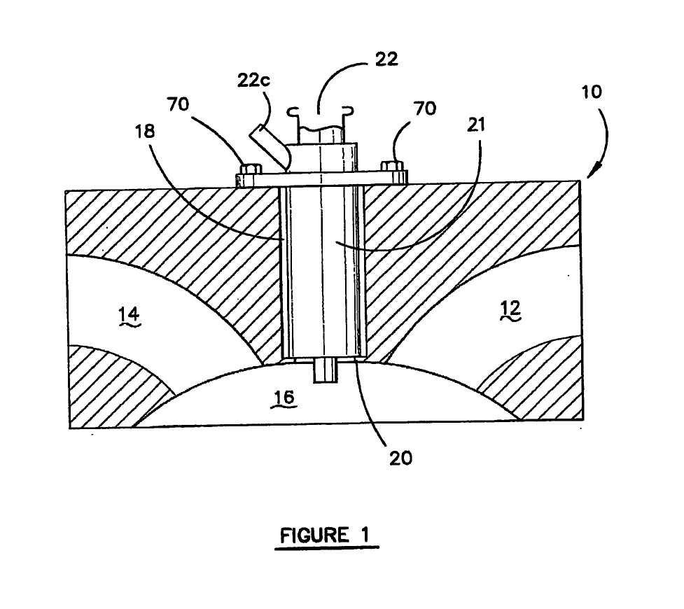

FIG. 1 shows a standard direct injection system for a diesel engine in which a head 10 of the engine includes an inlet port 12, an exhaust port 14 and a combustion chamber 16. A bore 18 which forms an injector port is provided in the head 10 and has an inwardly directed flange 20 at its inner end. A fuel injector 21 is located in the bore 18 and rests on the flange 20 so as to seal the end of the bore 18.

Fuel is supplied to the injector 18 via supply 22 so the fuel can be ejected from the injector 21 into the chamber 16.

FIG. 2 shows the first embodiment of the present invention. Like reference numerals indicate like parts to those described with reference to FIG. 1.

FIG. 2 also shows the engine block 30 and a piston 32 within the combustion chamber 16. It should be noted that the head 10 is separated from the block 30, but obviously sits on the block 30 and is secured to the block 30 in the conventional manner.

Injector 21 is located in the bore 18 in the same manner as described with reference to FIG. 1, except that in this embodiment, the end 23 of the bore 18 which communicates with the combustion chamber 16 is open. In the preferred embodiment, in order to ensure that the end 23 is open, a spacer collar 25 is located in the bore 18 and sits on the flange 20. The spacer collar 25 therefore allows fluid communication between the combustion chamber 16 and a heating chamber 40 which is defined between the bore wall 18a, the injector 21 and the closed or sealed end 42 of the bore 18 which is remote from the end 23.

In the embodiment shown in FIG. 2, the collar 25 is provided with a plurality of holes 27 which pass through the side wall of the collar to facilitate the flow of gas in the chamber 16 into the heating chamber 40 and allows the extraction of gas from the heating chamber 40 back into the chamber 16.

The spacer collar 25 also serves to lift the injector 21 within the bore 18 from the position it would normally occupy, as is shown in FIG. 1, to ensure that the electric section 21a of the injector 21 is outside the bore which is defined between the sealed end 42 and the end 23. In other words, the body of the injector 21 in which the electric components for operating the injector, and which are shown by reference 21a, is exterior of the heating chamber 40. The injector 21 has an electric connector 21c for supplying power to the injector. The portion 21b of the injector 21 in which the fuel is stored, and which is the end region of the injector, is the part of the injector which, together with the bore wall 18a and the sealed end 42, define the heating chamber 40. The injector 21 may also have a tip in the form of a projecting tip 29 from which the fuel is ejected. The tip 29 is adjacent the end 23 so that fuel is directly injected into the combustion chamber 16.

As is known in diesel engines, the fuel which is ejected into the engine is ignited by compression of gases within the chamber 16 during the compression stroke of the piston 32. That is, as the piston 32 rises in the chamber after the collection of intake air through the inlet 12, the pressure of the air increases thereby heating the air to a sufficient temperature to cause combustion of the fuel and air mixture within the combustion chamber 16. However, as the piston rises on its compression stroke and compresses the air within the chamber 16, the air is also pushed through the open end 23 into the heating chamber 40 so that the hot compressed air created by each compression stroke heats the end region or fuel storage section 21b of the injector 21, thereby elevating the temperature of the fuel stored in that section of the injector. The result of this, as is explained in detail in our aforesaid International application, is that the fuel in the end region 21b is heated to such an extent that as soon as it is ejected from the injector 21, the fuel immediately converts to a vapour state because of the elevated temperature of the fuel and the change in pressure experienced by the fuel when the fuel leaves the injector 21. Thus, the fuel is in an ideal state for combustion within the chamber 16, thereby providing the fuel economy and other advantages which are described in detail in our aforesaid International application.

During the operating cycle of the engine, air is drawn through the inlet port 12 during the suction stroke of the piston 32. The air is then compressed by the compression stroke of the piston, and when the piston approaches top dead centre, fuel is ejected from the injector 21. The compression of the air in the compression stroke therefore elevates the temperature of the vaporised fuel so as to cause ignition. Because the air has been substantially wholly compressed prior to ejection of the fuel from the injector 21, substantially none of the fuel vapour enters the heating chamber 18. Furthermore, because the fuel leaves the injector and immediately converts to vapour, all of the ejected fuel is available for combustion, thereby greatly improving efficiency.

In the embodiment of FIG. 2, the end 42 of the bore 18 is sealed by an O-ring type seal 50. The O-ring may be held in place by a suitable plate (not shown) or other device if necessary.

FIG. 5 shows a further embodiment in which like reference numerals indicate like parts to those previously described. In this embodiment, the collar 25 is of the type shown in FIGS. 4A, 4B and 4C. As shown in FIG. 4A, the collar is an annular ring and slots 51 (see FIG. 4C) are cut into the side wall of the annular ring 25 to provide a passage through which the compressed gases within the chamber 16 can pass into the heating chamber 40. In this embodiment, the end 42 is sealed by a generally annular seal plate 60 of the type shown in FIGS. 7 and 7A. The plate 60 is annular in configuration and has two lugs 61 which are diametrically opposed and provided with holes 63 for enabling a bolt 70 to pass through the holes and through a flange 21c on the fuel injector 21 so as to secure the injector 21 to the head 10 and also seal the end of the heating chamber 40.

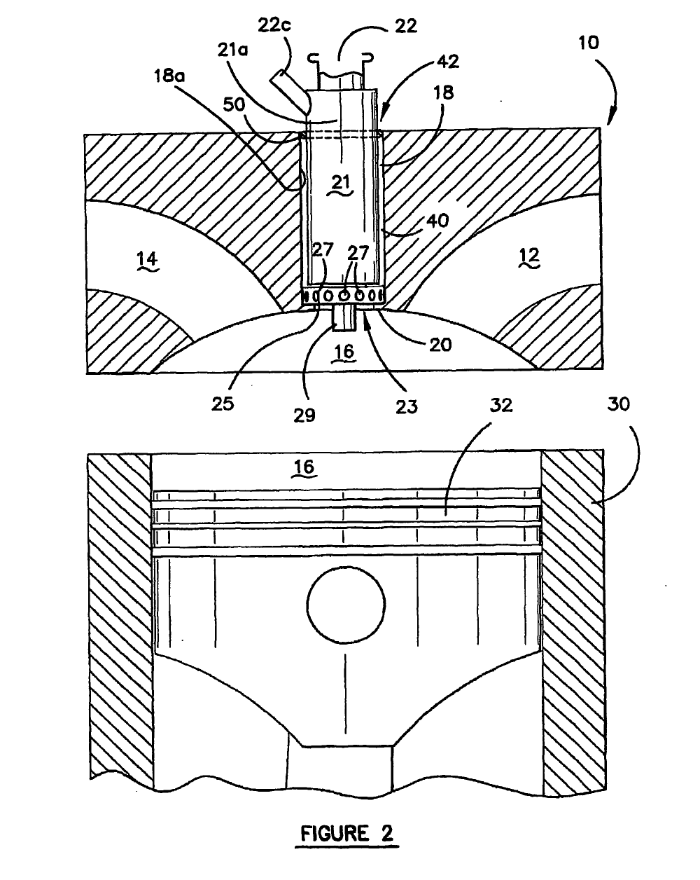

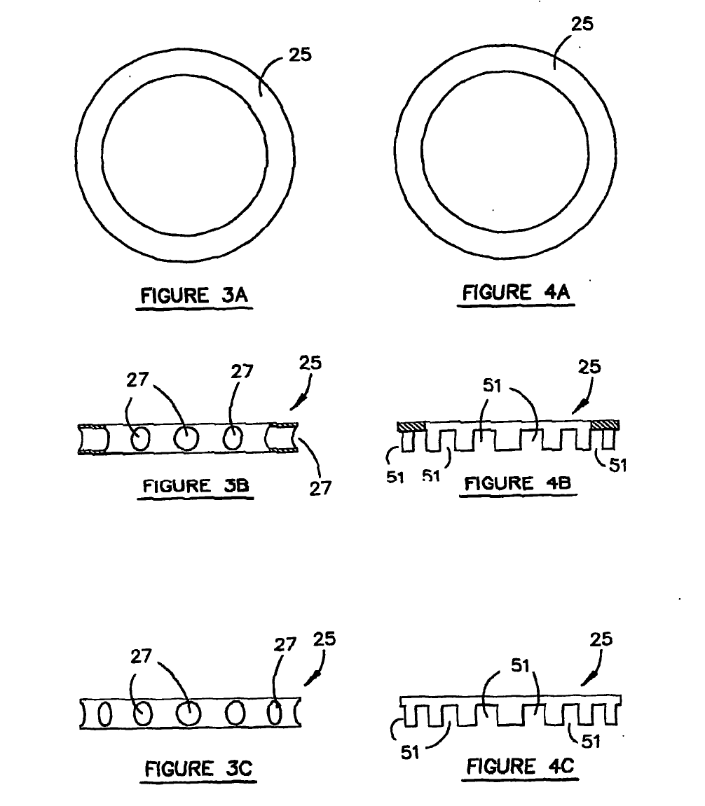

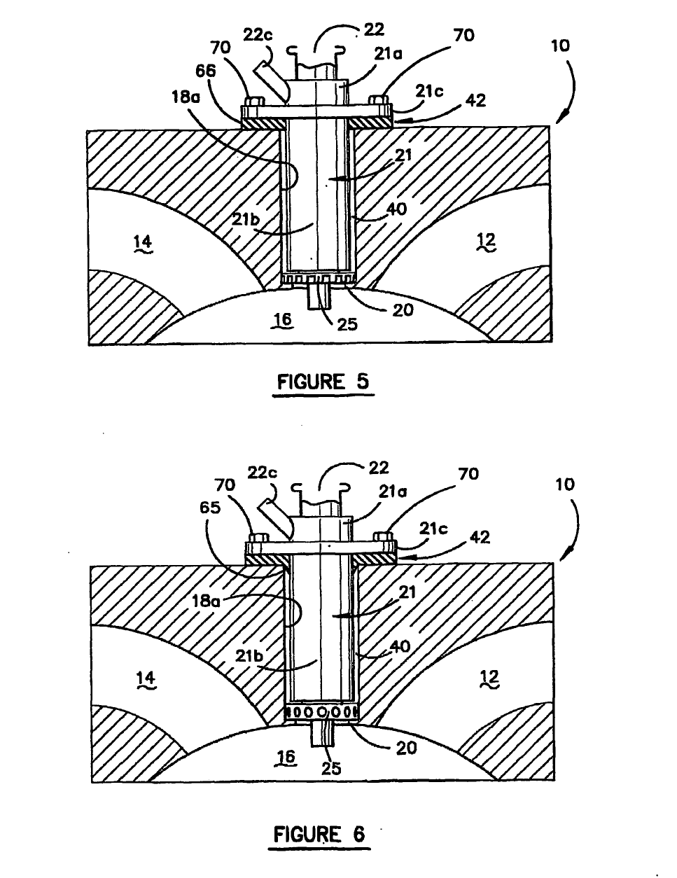

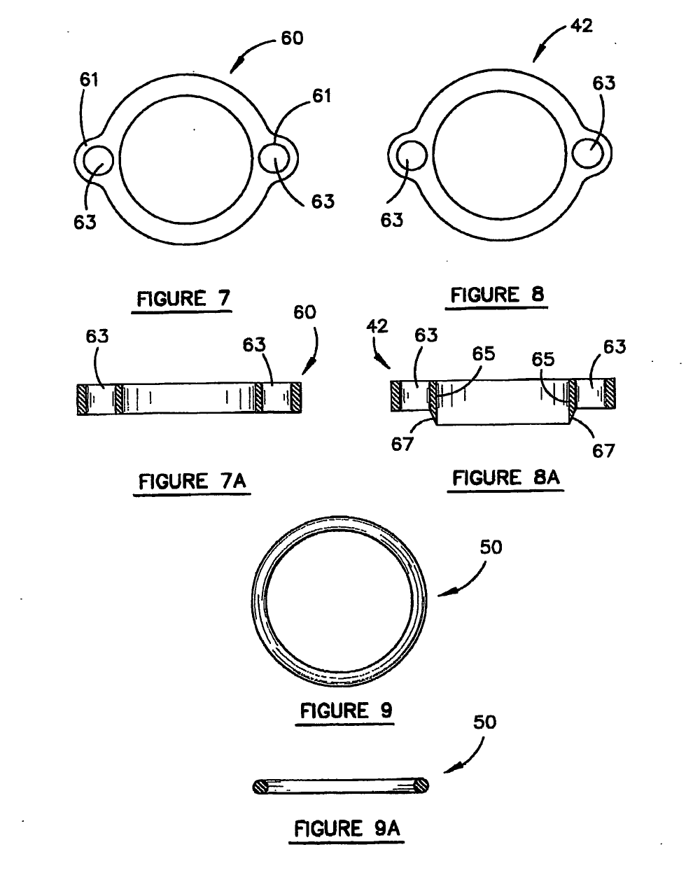

In FIG. 6 the collar 25 is of the type shown in FIGS. 3A, 3B and 3C in which the holes 27 previously described are provided in the side wall of the collar 25 to facilitate the passage of compressed gas between the heating chamber 40 and the combustion chamber 16.

In this embodiment, the sealing plate 42 is similar in plan view to that shown in FIG. 7, as is illustrated in FIG. 8. However, in cross-sectional view shown in FIG. 8A, the plate 42 has an inner downwardly projecting wall 65 which has a tapered outer end 67 which locates within the bore 18. Again, the plate 42 is secured in place by bolts 70 which pass through the holes 63 and screw into the head 10.

FIG. 9 shows a still further embodiment in which the seal is in the form of an O-ring of the type shown in FIG. 2.

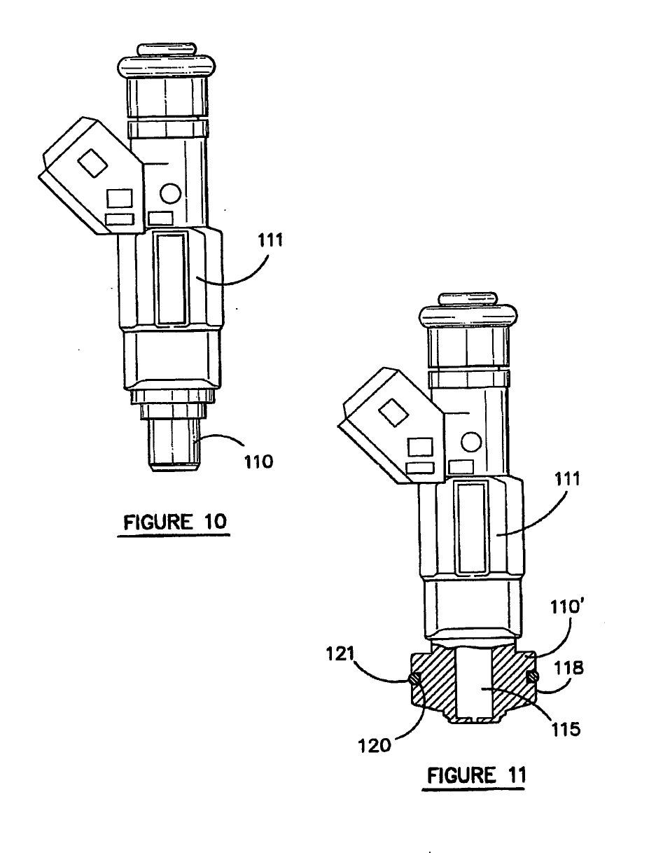

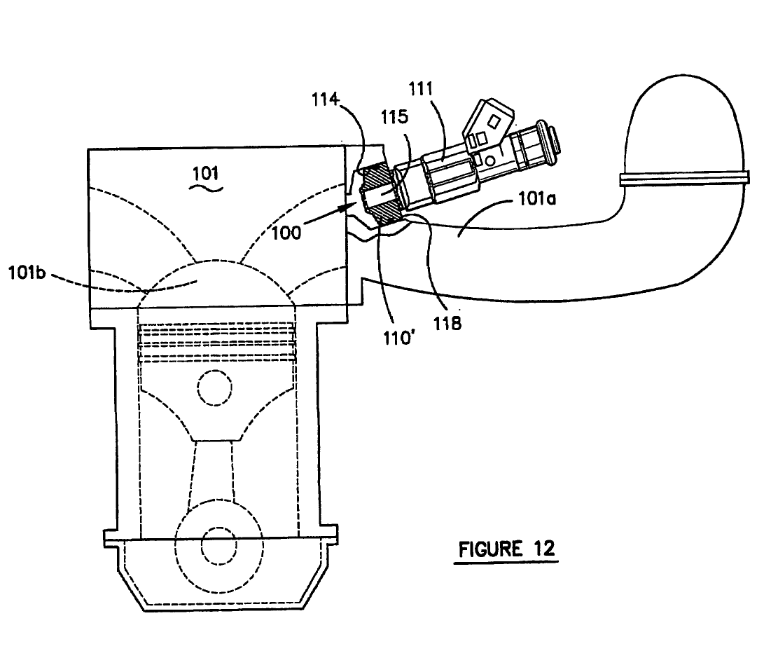

FIGS. 10 to 12 show a further embodiment of the invention. FIG. 10 is a view of a conventional injector typical of those used in petrol or gasoline type engines, and which locate in an injector port 100 (see FIG. 12) of an inlet manifold 101a of a vehicle engine 101.

The injector of FIG. 10 includes an end region 110 and an operating section 111 in which the electronic operating components such as a coil, pintle and the like are housed for operating the injector 111 so that the pintle can be moved away from a seat in the end region 110 to enable fuel to be ejected from the injector under the control of a vehicle management system (not shown) which supplies electrical signals to the injector in a manner which is well known.

In conventional systems, the end region 110 locates in the injector port 100 and is isolated from the wall 114 of the injector port by spacers or O-rings. This is done specifically to maintain the injector end region relatively cool, and therefore to maintain the fuel in the injector end region 110 also relatively cool. Thus, in the conventional system, heat is not conducted from the injector port wall 114 to the end region 110 of a conventional injector.

The injector shown in FIG. 11 and according to the preferred embodiment of this aspect of the invention, is the same as the injector shown in FIG. 10, except that the end region 110′ is enlarged and configured so that it will make thermal contact with wall 114 of the port 100. Thus, the heat of the engine is conducted from the wall 114 to the end region 110′, and therefore to the fuel storage section shown schematically at 115 in FIG. 12. Thus, the fuel is heated to an elevated temperature so that when the fuel is ejected from the injector, the fuel immediately converts to vapour because of the elevated temperature of the fuel, and the change in pressure experienced by the fuel when the fuel leaves the injector. Thus, the fuel is in an ideal state for combustion within the chamber 101b as previously described.

In the preferred embodiment of the invention, the enlarged end region 110′ is preferably generally cylinder or disc shape in configuration. However, other shapes are possible depending on the shape of the injector port 100 and consistent with the concept of providing direct conduction of heat from the engine 101 to the end region 110′ to heat the fuel in the manner described above.

The end region 110 is generally in the form of a solid metal end region or other conducting material and, as is apparent from the foregoing description, is an integral part of the end region of the injector. Thus, the end region 110 has an outer wall 118 and the enlarged end region 110 is solid material through to the chamber 115. Thus, heat is readily conducted from the wall 114 of the injector port 100 to the wall 118 of the end region 110′ to the fuel in the storage section 115.

Thus, it will be apparent that during operation of the invention, the end region 110′ is continuously heated so as to maintain the fuel in the storage 115 at the elevated temperature substantially at all times during operation of the engine.

Accordingly, no modification or interference with the standard size of the engine inlet port 100 needs to occur, and the injector itself is dimensioned so that it will fit and make thermal contact with the injector port to provide the heat transfer. Thus, the inlet port 100 can be left standard without any modification and, furthermore, the injector itself includes all of the features in order to effect heat transfer to the fuel in the injector. Thus, the amount of parts is minimised and, indeed, the amount of parts is no greater than in a standard fuel injector system in which the injector is spaced from the port 100.

In initial engine start-up when the engine is starting from cold, the enlarged end region 110′ may also include an electrical heater to heat the end region more quickly to the elevated temperature until such time as the engine is warm enough so as to maintain the end region 110′ and therefore the fuel at the elevated temperature, by way of conduction of heat from the engine via the wall 114 of the port 100. The electrical heating element in this embodiment of the invention would be incorporated into the end region 110′ and would operate generally as described in our co-pending International Application No. PCT/AU03/01156 (the contents of which are incorporated into this specification by this reference). In accordance with the teachings of that International application, the electrical heating is switched off when the temperature is elevated to the required temperature, but may again switch on if, for any reason during operation of the engine, the end region 110′ drops below the required temperature.

As is apparent from FIG. 12, the operating section 111 of the injector is maintained in a relatively cooler environment, and therefore the heating of the end region 110′ by the direct conduction of heat from the wall 114 does not overheat the operating section 111, which would cause failure of the electronic componentry in the operating section 111.

In one embodiment of the invention, the end region 110′ may include a groove 120 as is shown in FIG. 11, for containing an O-ring 121 to facilitate sealing of the enlarged end region 110′ in the injector port 100.

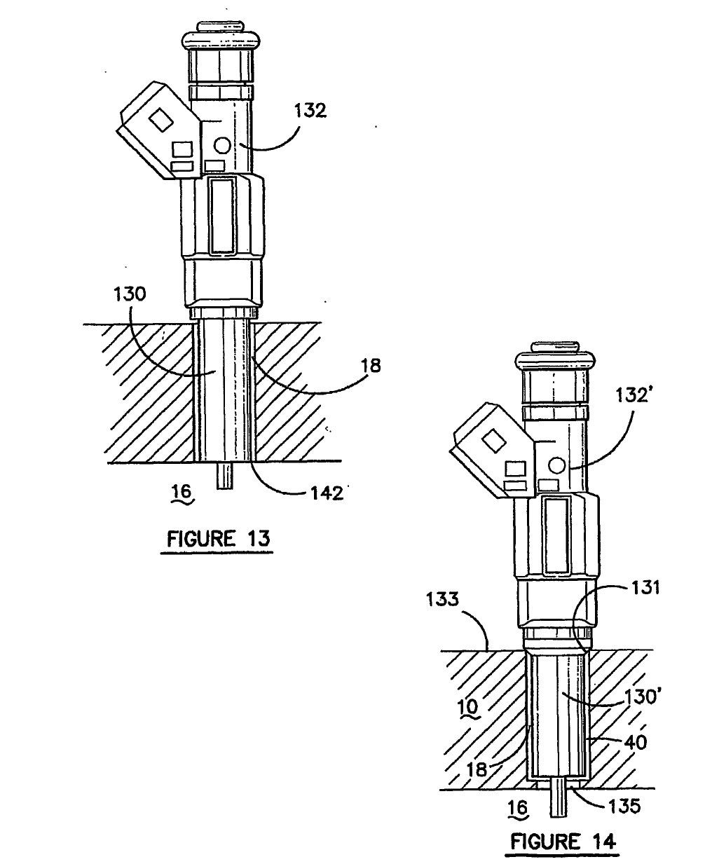

FIG. 13 is a view of a conventional injector used for injecting fuel directly into a cylinder of an engine. As is well known, this injector includes a body in which the operating components are located and an end region 130 which locates in injector port 18. The injector is sealed in the port by a seal 142 to prevent exhaust gases from moving into the injector port.

As has been made clear in relation to the embodiments of FIGS. 1 to 9A, the end of the port corresponding to the seal 142 in the conventional system described above is left open so exhaust gases can move into the injector port to heat the end region 130.

FIG. 14 is a view of a modified injector, particularly for diesel engines (which could also be used for petrol engines) according to another embodiment of the invention which enables the concept of FIGS. 1 to 9A to be more easily implemented.

In the embodiment of FIG. 14, the injector has a body 132′ in which the operating components are located, and an end region 130′ which is slightly narrower than in the injector of FIG. 13, and a shoulder 131 is provided which can seat on the outer wall 133 of the cylinder head 10 to seal the injector port 18. The shoulder 131 is formed at a second end of the end region 130 remote from the end 29 from which the fuel is ejected. The shoulder 131 is in the form of an annular wall which seats on a part of the outer wall 133 of the cylinder head 10 at the periphery of the injector 18. The shoulder 131 can be metal or could be provided with a sealing gasket-type material so as to form an effective seal with the periphery of the port 140 at the wall 133. The inner end 135 of the injector port 18 is left open so exhaust gases can move into the port 18 and into the chamber 40 to surround the end region 130′ to heat the end region, as described with reference to FIGS. 1 to 9A. The seal formed by the shoulder 131 seating on the wall 133 of the cylinder head 10 prevents the exhaust gases from escaping passed the injector in FIG. 14 through the port 18 to atmosphere.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. A diesel engine fuel delivery system for an engine which has a combustion chamber, a piston moveable in the combustion chamber, an air inlet port and an exhaust port, comprising:
a bore in the engine having a first open end communicating with the combustion chamber, and a second end remote from the first end, the bore having a bore wall;
a fuel injector located in the bore and having an injection tip adjacent the first end for direct injection of fuel into the combustion chamber, the injector having a fuel storage section in which fuel is stored for ejection from the injector and an operating section for operating the injector to eject the fuel from the tip of the injector;
the second end of the bore being closed;
a heating chamber defined by the bore wall, the closed second end of the bore and the injector;
the injector being located in the bore so that the fuel storage section is within the heating chamber; and
wherein during a compression stroke of the piston gas within the combustion chamber is compressed and forced through the first open end of the bore into the chamber to heat the fuel storage section of the injector so as to raise the temperature of the fuel in the fuel storage section so that as soon as the fuel leaves the injector, the fuel substantially immediately converts to vapour state because of the heating of the fuel and the change in pressure experienced by the fuel when the fuel leaves the injector and enters the chamber.

2. The system of claim 1 wherein the injector has a mechanical operating section which is operated by fuel pressure.

3. The system of claim 1 wherein the injector has an electric operating section, the electric operating section being exterior of the chamber to prevent the heating within the chamber from destroying the electric operating section of the injector.

4. The system of claim 1 wherein the bore has an inwardly directed flange and a collar located on the flange for receiving an end of the injector so as to raise the injector slightly in the bore and to provide a passage through which the gases compressed in the cylinder can pass into the heating chamber.

5. The system of claim 4 wherein the second end of the bore is closed by a sealing element.

6. The system of claim 5 wherein the sealing element is a shoulder formed on the injector remote from the tip for sealing the second end of the bore.

7. The system of claim 4 wherein the collar has a generally annular ring and has apertures or holes to facilitate the passage of gas from the combustion chamber into the heating chamber, and from the heating chamber back into the combustion chamber.

8. A fuel injector for a fuel delivery system for delivering fuel to a cylinder of a vehicle engine, the injector comprising:
an injector body having an end region which comprises a fuel storage section in which fuel is stored for ejection from the injector, and an operating section for operating the injector to eject the fuel from the end region; and
a heating component for substantially continuously heating the end region of the injector when the injector is in operation supplying fuel to the cylinder, to maintain the end region and therefore the fuel in the fuel storage section at a temperature so that when the fuel is ejected from the injector, the fuel immediately converts to a vapour state because of the elevated temperature of the fuel and the change in pressure experienced by the fuel when the fuel leaves the injector, and wherein the heating component comprises a portion of the injector adjacent the end region for making contact with a wall of an injector port so that heat is directly conducted from the vehicle engine to the injector.

9. The injector of claim 8 wherein the heating component comprises an enlarged end region of the injector which is dimensioned so that when the injector is inserted into an injector port of the vehicle engine, the enlarged end region is in thermal contact with a wall defining the injector port so that heat is transferred from the engine by direct conduction to the enlarged end region of the injector, and therefore to the fuel in the fuel storage section.

10. A fuel delivery system for a vehicle engine which includes a cylinder and an injector port having a wall, the fuel delivery system comprising:
an injector having an ejector body which is formed with an end region which comprises a fuel storage section in which fuel is stored for ejection from the injector, and an operating section for operating the injector to eject the fuel from the end region; and
the end region of the injector having a dimension so that at least part of the end region of the injector body makes thermal contact with the wall of the injector port so that during operation of the vehicle engine, heat is conducted from the engine via the wall of the injector port to the enlarged portion of the injector to thereby heat fuel in the fuel storage section so that when fuel is ejected from the injector, the fuel immediately converts to a vapour state because of the elevated temperature of the fuel and the change in pressure experienced by the fuel when the fuel leaves the injector.

11. The system of claim 10 wherein the end region has an outer wall and the end region is dimensional so that substantially all of the outer wall contacts the wall of the injector port.

12. The system of claim 11 wherein the end region is substantially cylinder or disc shape, and has an outer wall which contacts substantially the entirety of the wall of the injector port.

13. The system of claim 10 wherein the end region includes a seal for sealing the end region in the injector port.

14. An injector for a fuel delivery system for delivering fuel to a cylinder of an engine, the engine having an injector port for receiving the injector, said injector comprising:
an injector body;
an end region extending from the injector body for storing fuel to be ejected from the injector, the end region having a first end from which the fuel is ejected, and a second end;
the end region having a dimension so that when the end region is located in the injector port, a heating chamber is formed between the end region of the injector and a wall of the injector port;
the first end of the injector being free of any seal so exhaust gas can move past the first end and into the chamber when the injector is located in the injector port and the engine is operating; and
a seal adjacent the second end of the end region for sealing the injector in the injector port.

15. The injector of claim 14 wherein the seal is formed by a shoulder located at the second end and which forms a transition between the end region and the injector body so that the shoulder can seat on part of an outer wall of the engine in which the injector port is formed.

16. The injector of claim 15 wherein the shoulder is a tapered annular wall for seating on a part of the outer wall of the engine at the periphery of the injector port.
